(19) United States
(12) Patent Application Publication
(10) Pub. No.: US 2011/0246337 A1
(43) Pub. Date: Oct. 6, 2011

(54) METHOD AND SYSTEM FOR MANAGING AN ASSET IN A DATABASE SYSTEM

(75) Inventors: Nathan Wisman, San Francisco, CA (US); Andrew Sopko, San Francisco, CA (US)

(73) Assignee: salesforce.com, inc., San Francisco, CA (US)

(21) Appl. No.: 12/969,200

(22) Filed: Dec. 15, 2010

Related U.S. Application Data
(60) Provisional application No. 61/319,781, filed on Mar. 31, 2010.

(51) Int. Cl. G06Q 10/00

(52) U.S. Cl. 705/28

(57) ABSTRACT

A method for managing an asset in a database system is provided. The method embodiment includes receiving by a node hosting an asset management service module asset information corresponding to an asset, and generating automatically by the asset management service module an asset identifier based on the received asset information. In an embodiment, the asset identifier uniquely identifies the asset and includes a manufacturer's serial number of the asset and at least one of a make and a model of the asset. The asset information is associated with the asset identifier, and the asset information and the asset identifier are stored in a database system.

### CLAIM OF PRIORITY

This application claims the benefit of U.S. Provisional Patent Application 61/319,781 entitled, METHOD AND SYSTEM FOR PROTECTING ASSETS by Nathan M. Wisman et al., filed Mar. 31, 2010 (Attorney Docket No. SFC1P101+/289PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to managing technology assets in a database network system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Modern workplace environments utilize an assortment of technology assets. Such assets can include, but are not limited to, computers, servers, printers, routers, phones and projectors, just to name a few. Often times, employers provide employees with one or more technology assets for work related functions. For example, workers can be provided with handheld communication devices, portable computers, and the like. While a worker is authorized to use the technology assets for work related tasks, the technology assets remain the responsibility and/or property of the employer. Accordingly, it is incumbent upon the employer to track and manage the provided assets.

In a large enterprise, tens of thousands of technology assets might be used in various offices and plants, and/or might be provided to employees throughout its workforce. Managing these assets presents substantial challenges. For instance, users and their assets might be located or relocated throughout the world, and/or different offices of an enterprise might use different assets. Moreover, strategies for managing the assets can vary from office to office or from department to department.

Accordingly, it is desirable to provide techniques enabling the management of technology assets in a database network system.

### BRIEF SUMMARY

In accordance with embodiments, there are provided mechanisms and methods for managing an asset. These mechanisms and methods for managing an asset can enable embodiments to provide the capability to track an asset from receipt to disposal, and to link the asset to support cases, users and/or other assets. The ability of embodiments to provide such technique can enable a centralized asset management platform thereby allowing an enterprise to track and manage assets more effectively.

In an embodiment and by way of example, a method for managing an asset is provided. The method embodiment includes receiving by a node hosting an asset management service module asset information corresponding to an asset, and generating automatically by the asset management service an asset identifier based on the received asset information. In an embodiment, the asset identifier uniquely identifies the asset and includes a manufacturer's serial number of the asset and at least one of a make and a model of the asset. The asset information is associated with the asset identifier, and the asset information and the asset identifier are stored in a database system.

While one or more implementations and techniques are described with reference to an embodiment in which techniques for managing an asset is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an operational flow diagram illustrating a high level overview of a technique for managing an asset in a database system according to an embodiment;

FIG. 2 illustrates a representative system for managing an asset in a database system according to an embodiment;

FIG. 3 is an operational flow diagram illustrating a high level overview of a technique for managing an asset in a database system according to another embodiment;

FIG. 4A illustrates a graphical user interface that may be displayed for receiving asset information corresponding to an asset according to an exemplary embodiment;

FIG. 4B illustrates a graphical user interface that may be displayed in response to the selection of an upload button according to an embodiment;

FIG. 5A illustrates a graphical user interface for managing an asset in a database system according to an exemplary embodiment;

FIG. 5B illustrates a graphical user interface that may be displayed in response to the selection of an asset transaction number according to an exemplary embodiment;

FIG. 6 illustrates a block diagram of an example of an environment wherein an on-demand database service might be used; and

FIG. 7 illustrates a block diagram of an embodiment of elements of FIG. 6 and various possible interconnections between these elements.

### DETAILED DESCRIPTION

### General Overview

Systems and methods are provided for managing an asset in a database system.

In the modern workplace environment, technology assets support every aspect of an enterprise's business operation, and in many circumstances are its core business service. Such assets can include, but are not limited to, desktop computers, servers, printers, routers, and phones, just to name a few. In addition to equipping offices and plants, businesses also typically provide employees with one or more technology assets for work related functions. For example, workers can be provided with handheld communication devices, laptop computers, and the like. While a worker is authorized to use the technology assets for work related tasks, the technology assets remain the responsibility and/or property of the employer. Accordingly, it is incumbent upon the employer to track and manage its assets. Managing these assets presents substantial challenges, especially when a large enterprise provides tens of thousands of technology assets to offices and workers throughout a nation and/or the world.

To date, there is no effective and/or efficient way of managing a diverse array of technology assets. The following exemplary embodiments illustrate mechanisms and methods that can enable an enterprise to track an asset from receipt to disposal, and to link the asset to support cases, users and/or other assets. The ability of embodiments to provide such technique can enable a centralized asset management platform thereby allowing the enterprise to track and manage assets more effectively.

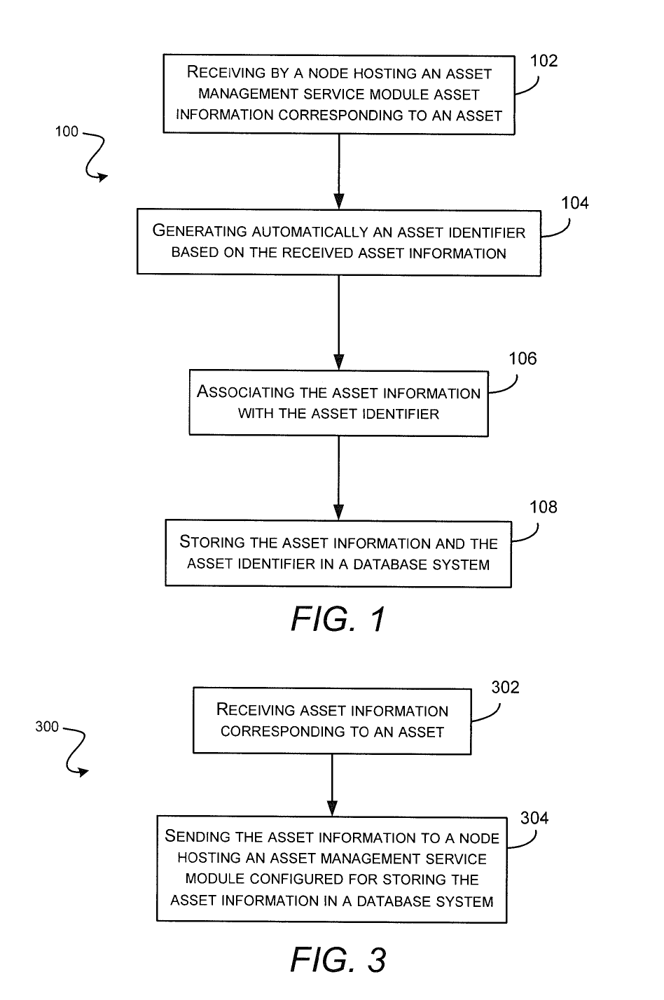

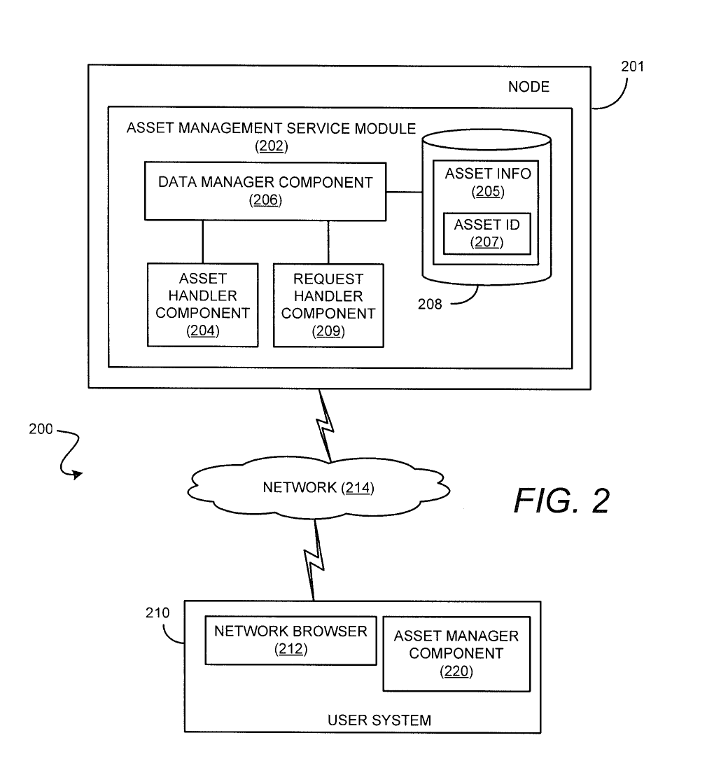

FIG. 1 illustrates a method 100 for managing an asset in a database system according to an embodiment. FIG. 2 illustrates a representative system 200 for managing an asset in a database system according to an embodiment. In particular, FIG. 2 illustrates an arrangement of components configured to implement the method 100 of FIG. 1, which also can be carried out in environments other than that illustrated in FIG. 2. In an embodiment, the database system may be implemented as a multi-tenant database system. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Illustrated in FIG. 2 is an asset management service module 202 including components adapted for operating in an execution environment provided by a node 201 and/or multiple nodes as in a distributed execution environment. Exemplary nodes can include desktop computers, servers, networking nodes, notebook computers, PDAs, mobile phones, digital image capture devices, and the like. One example of such a node 201 will be described later in greater detail during reference to later illustrated embodiments. The asset management service module 202 can include a data store 208 for storing information and other data objects. In an embodiment, the asset management service module 202 can be configured to receive and send information from and to a user system 210 via a network 214. The network 214 may be a Local Area Network (LAN) and/or a Wide Area Network (WAN) including the Internet. The user system 210 may include an application that allows network communication between the user system 210 and the asset management service module 202. Such an application can be, in an embodiment, a network browser 212 (e.g., Microsoft Internet Explorer, etc.) or the like that is capable of sending and receiving information to and from the node hosting the asset management service module 202.

FIG. 1, as stated above, illustrates a method for managing assets in a database system according to an embodiment. In this case, the method 100 can be implemented in the context of the node 201 hosting the asset management service module 202, but can also be implemented in any desired environment. With reference to FIG. 1, the method begins, in block 102, by receiving asset information corresponding to an asset by the node 201 hosting the asset management service module 202. According to an embodiment, the asset management service module 202 includes means for receiving asset information corresponding to an asset. For example, FIG. 2 illustrates an asset handler component 204 configured for receiving asset information corresponding to an asset.

In an embodiment, the asset handler component 204 can be configured to receive the asset information corresponding to an asset from the user system 210 via the network 214. The network 214 can support any protocol compatible with a configuration of the asset management service module 202 and/or other components hosted by the node 201 including the asset management service module 202. The asset information corresponding to the asset can include a variety of information. For example, the asset information can include, but is not limited to, a manufacturer's serial number, a make and a model of the asset, and a purchase order (PO) number. In addition, the asset information can identify a location of the asset, the asset's status, technical specifications of the asset, e.g., the asset's memory capacity, processor and operating system, and financial information associated with the asset, e.g., lease terms and/or purchase cost. The asset information can include other types of information associated with the asset and is not limited to that information described herein.

Referring again to FIG. 1, when the asset information is received, an asset identifier is automatically generated based on the received asset information (block 104). According to an embodiment, the asset handler component 204 can be configured for automatically generating the asset identifier. For example, the asset handler component 204 can be configured to parse the received asset information and to generate automatically the asset identifier from the parsed asset information. According to an exemplary embodiment, the asset identifier can uniquely identify the asset, and as stated above, is based on the asset's asset information. For example, the asset identifier can include the manufacturer's serial number, and the make and/or model of the asset. By including the make and/or model with the serial number, the risk of duplicating an asset identifier is low, if not nonexistent. The asset identifier can include other types of asset information in addition to the serial number and the make and/or model of the asset, and is not limited to that information described herein.

Referring again to FIG. 1, once generated, the asset identifier is associated with the asset information (block 106). According to an embodiment, the asset handler component 204 can be configured for performing this task. Once associated, the asset information and the asset identifier are stored in a database system (block 108). According to an embodiment, the asset management service module 202 includes means for storing the asset information with the asset identifier. For example, FIG. 2 illustrates a data manager component 206 configured for storing the asset information 205 with the asset identifier 207 in a database system 208. According to an exemplary embodiment, the data manager component 206 can be configured to receive the asset information 205 and the associated asset identifier 207 from the asset handler component 204, and optionally to process the information 205 and identifier 207 so that it can be stored in the database system 208.

Alternatively or additionally, asset information for a plurality of assets can be received in a batch and stored in the database system 208. In an embodiment, the asset handler component 204 can be configured to receive asset information corresponding to a plurality of assets. For example, the asset handler component 204 can receive asset information corresponding to a bulk shipment of laptop computers from a single manufacturer or vendor corresponding to a single purchase order. In this embodiment, the asset handler component 204 can be configured to parse the asset information corresponding to each of the plurality of assets and to generate an asset identifier for each of the plurality of assets. Moreover, the asset handler component 204 can be configured to associate the asset information with the asset identifier of each of the plurality of assets, and the data manager component 206 can be configured to store the information and the identifier of each of the plurality of assets in the database system 208.

FIG. 3 illustrates a method for managing assets according to another embodiment. In this case, the method 300 can be implemented in the context of the user system 210 of FIG. 2. The method 300 may, however, be carried out in any desired environment.

Referring to FIG. 2 and FIG. 3, asset information corresponding to an asset is received in block 302. In an embodiment, the user system 210 can include an asset manager component 220 configured for receiving the asset information corresponding to the asset. The asset information can be received in a number of ways. For example, it can be received via manual input by a user using an input device such as a keyboard, via audio input, and/or via a scanning or imaging device. In an embodiment, a scanning device can be used to read a barcode or other asset information associated with the asset. In another embodiment, an imaging device in a handheld phone can be used to scan the barcode associated with the asset. The mentioned techniques can be used alone or together in combination, and of course other information collecting techniques can be implemented.

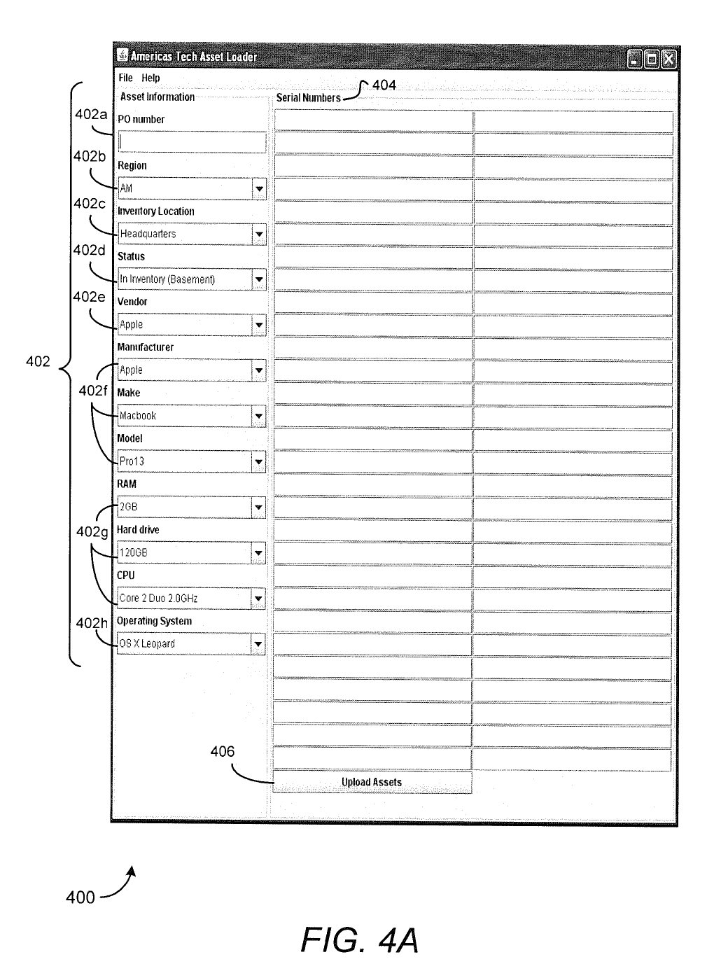

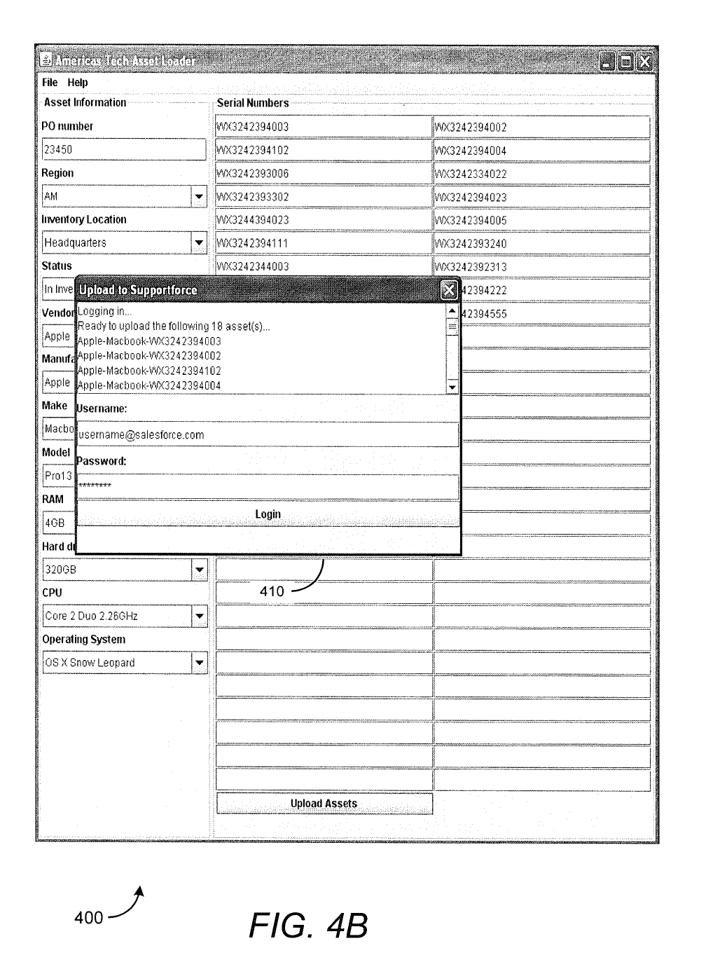

FIG. 4A illustrates a graphical user interface representing an asset loader 400 that may be displayed for receiving asset information corresponding to an asset according to an exemplary embodiment. In an embodiment, the asset loader 400 can be provided by the asset manager component 220 in the network browser 210. Alternatively or additionally, the asset loader 400 can be provided by the asset management service module 202.

As shown, the asset loader 400 includes a plurality of shared asset information fields 402 that each correlate to different attributes of an asset. According to an embodiment, the information in the shared asset information fields 402 can be information common to a plurality of assets. For example, the plurality of shared asset information fields 402 can include a PO number field 402a for designating a purchase order under which the asset was procured, a region field 402b and a location field 402c for indicating the receiving location of the asset, a status field 402d for indicating the asset's status, e.g., “in inventory”, “provisioned”, etc. Also included can be a vendor field 402e for identifying the vendor from which the asset was purchased, manufacturer-specific fields 402f identifying, for example, the asset's manufacturer, make and model, hardware-specific fields 402g specifying, for example, the asset's memory specifications and processor type, and an operating system field 402h for identifying the asset's operating system. Of course, the types of shared asset information fields 402 can vary and are not limited to those described above.

In an embodiment, the asset loader 400 can be configured to populate automatically at least one shared asset information field 402 based a value provided in another shared asset information field 402. For example, a particular enterprise might require that a particular model type have a specified hardware configuration so that when the model type is entered, the hardware-specific fields 402g can be automatically populated based on the enterprise's rules. In another embodiment, the asset loader 400 can be configured to provide a pull down menu offering a list of choices for a value of a field, e.g., the status field 402d, so that the user can select a value. In addition or alternatively, an auto-filling feature can be implemented for many fields 402 to improve data accuracy and to increase efficiency.

In addition, the asset loader 400 includes a serial number field 404 for specifying a serial number associated with each asset. Unlike the information in the shared asset information fields 402, the information in the serial number field 404 is specific to each asset. As shown in FIG. 4A, a plurality of serial number fields 404 can be provided by the asset loader 400 such that a plurality of assets that share asset information in the shared asset information fields 402 can be processed in a batch.

As mentioned above, the shared asset information and the serial number information can be received using a number of techniques. The information can be entered manually by the user, e.g., via a keyboard, or automatically by a scanning or imaging device, e.g., via a handheld scanner or camera, or using a combination of manual and automatic entry. Taken together, the information provided in the plurality of fields 402, 404 comprise the asset information corresponding to the asset.

According to an exemplary embodiment, after receiving the shared asset field information 402 and the serial number field information 404, the asset manager component 220 can be configured for automatically generating an asset identifier associated with each asset based on the asset's serial number. The asset identifier can include the information in the serial number field 404 and the information in one or more of the manufacturer-specific fields 402f , e.g., the make and/or model number of the asset.

Referring again to FIG. 3, the asset information is sent to a node hosting an asset management service module configured for storing the asset information in a database system (block 304). In an embodiment when an asset identifier is generated automatically by the asset manager component 220, the process of sending the asset information corresponding to the asset includes sending the asset identifier as well. In an embodiment when asset information corresponding to a plurality of assets is received and, optionally a plurality of asset identifiers is generated for each of the plurality of assets, the asset information, and optionally the asset identifiers, are sent to the node hosting the asset management service module. In an embodiment, the network browser 212 can be configured for sending the asset information to the asset management service module, e.g., service module 202, for storage in a database system.

As shown in FIG. 4A, the asset loader 400 can include an upload button 406, which when selected, initiates the sending of the asset information to the asset management service. FIG. 4B illustrates a graphical user interface that may be displayed in response to the selection of the upload button 406. As an option, an upload popup window 410 can be displayed for indicating which assets will be uploaded and the progression of the upload process. In an embodiment, the asset information can be sent from the network browser 212 via the network 214 to a node 201 hosting the asset management service 202 of FIG. 2.

Next, mechanisms and methods for managing an asset in a database system will be described with reference to example embodiments.

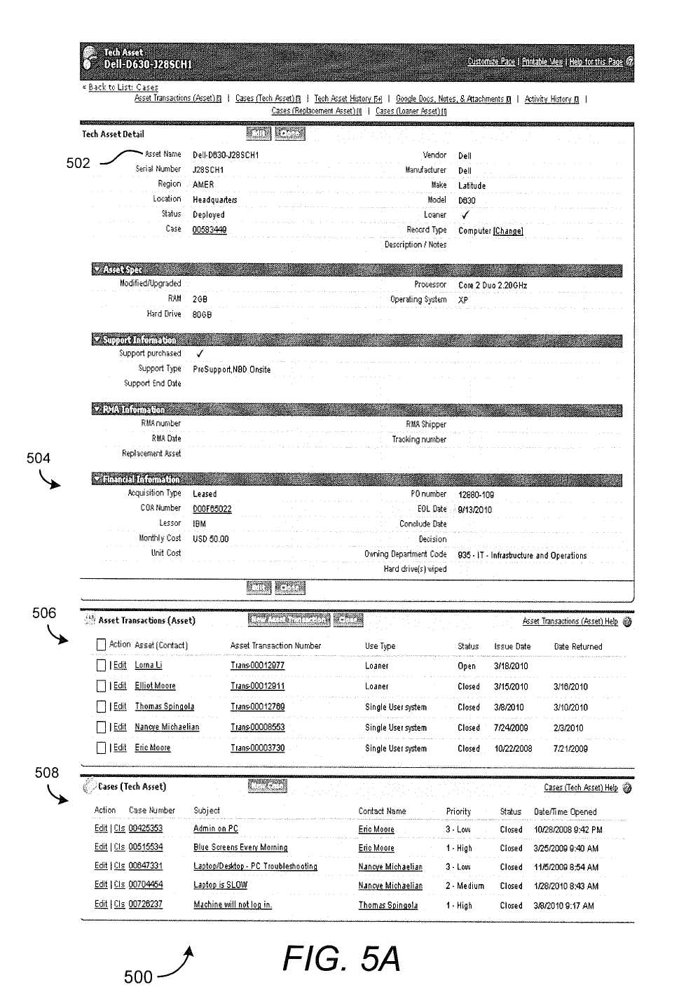

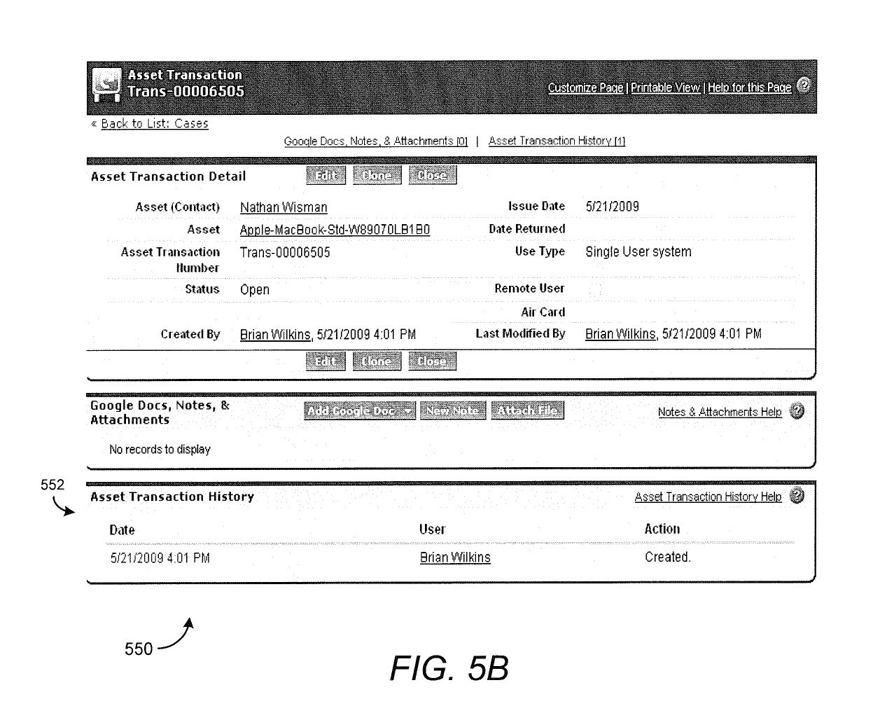

FIG. 5A illustrates a graphical user interface representing an asset object 500 for managing an asset in a database system according to an exemplary embodiment. The asset object 500 may be provided by an application service, e.g., the asset management service module 202, or by the asset manager component 220 for tracking and managing the end-to-end lifecycle of the asset. The asset object 500 can be accessible by an administrator for controlling asset procurement, deployment and/or disposal, or by any authorized user.

As shown, the asset object 500 includes the asset information and the asset identifier (e.g., asset name 502) associated with the asset. Additional information can also be included, such as, for example, financial data 504, user data 506, and technical support data 508. Other types of data can be tracked depending on various factors, such as, for example, the asset type, the nature of the enterprise, and the use of the asset, to name a few. Over the lifetime of the asset, the information in the asset object 500 can be updated and modified to reflect events affecting the asset.

For example, in an embodiment, when an asset is assigned to or returned by a user, the asset manager component 220 in a user system 210 can be configured for receiving user data and for sending the user data to the node 201 hosting the asset management service module 202 via the network 214. The user data can include, in an embodiment, a user name, an asset identifier associated with the asset, and at least one of an asset transaction number, a use type, a status, an issue date, and a return date. The asset transaction number can correspond to an identifier that associates the user with the event, e.g., the assignment or the return of the asset. The use type can identify how the asset is used, e.g., loaner, single user system, etc. The status, e.g., open or closed, can refer to the deployment status of the asset, and the issue and return dates can indicate when the asset was assigned to and returned by the user.

According to an embodiment, the asset management service module 202 can be configured for receiving the user data, for associating the user data with the asset identifier, and for storing the user data in the database system 208. Because the user data is associated with the asset identifier 207, it can also be associated with the asset information 205 corresponding to the asset. Over the life of the asset, the various users associated with the asset can be tracked. For example, the user data 506 in the asset object 500 can show that the asset is presently deployed, that it has been deployed to four previous users, and for each user the user data 506 can indicate how the asset is being or was used, and when it was issued and returned. In an embodiment, the asset transaction number 506a can be a look-up field to information associated with the user corresponding to that transaction.

For example, FIG. 5B illustrates a graphical user interface representing an asset transaction object 550 that may be displayed in response to the selection of an asset transaction number 506a in the asset object 500 according to an exemplary embodiment. As shown, the asset transaction object 550 can provide detailed information relating to the selected transaction as well as an asset transaction history 552 associated with the user. In an embodiment, the asset transaction history 552 can provide detailed information relating to what assets have been and/or are presently issued to the user. This information may be helpful in determining whether a particular user is careful or abusive with assets, and/or whether the user is authorized to use particular assets. Moreover, when a user is no longer employed by the enterprise, a list of assets to be returned can be generated thereby eliminating theft. In an embodiment, the asset transaction object 550 can include a look-up field to information associated with the asset such that the asset transaction object 550 and the asset object 500 cross-reference one another.

In another embodiment, when technical support is required for an asset, the asset manager component 220 in a user system 210 can be configured for receiving support data and for sending the support data to the node 201 hosting the asset management service module 202 via the network 214. The support data can include, in an embodiment, a support case number, an asset identifier associated with the asset, and at least one of a problem description, a contact name, a priority, a status, and an open date and time.

According to an embodiment, the asset management service module 202 can be configured for receiving the support data, for associating the support data with the asset identifier, and for storing the support data in the database system 208. Because the support data is associated with the asset identifier 207, it can also be associated with the asset information 205 corresponding to the asset. Over the life of the asset, various technical problems associated with the asset can be tracked. For example, the support data 508 in the asset object 500 can show that the asset has required technical support on five occasions, and on each occasion, the support data 508 can indicate a description of the problem, who the user was, and whether and when the problem was resolved.

In an embodiment, information in any or all of the fields in the asset object 500 can be searchable. For example, a support technician who is investigating a number of assets having a specified problem, can invoke the asset manager component 220 in a user system 210 and submit a request for any assets having the specified problem description, e.g., “Machine will not log in.” The asset manager component 220 can be configured for receiving the request for information relating to one or more assets, and for sending that request to the node 201 hosting the asset management service module 202 via the network 214.

The asset management service module 202 can be configured to receive the request, identify and retrieve the requested information from the database 208, and to return the requested information to the requesting user system 210. For example, a request handler component 209 in the asset management service module 202 can be configured, in an embodiment, for receiving the request for any assets having the specified problem. The data manager component 206 can be configured for identifying assets having the specified problem, and for retrieving asset information identifying the assets having the specified problem from the database 208. The request handler component 209 can be configured to return the retrieved information to the asset manager component 220 via the network 214. In turn, the asset manager component 220 can be configured for receiving the asset information identifying the assets having the specified problem, and for tracking automatically those assets. Moreover, this information may be helpful in determining which assets (makes and models) are most reliable for purchasing decisions, and/or in identifying trends that might indicate a defective component in a particular set of assets.

In another example, purchasing department personnel can verify that assets received in a shipment comply with those ordered in a purchase order. In this embodiment, a user can invoke the asset manager component 220 and submit a request to the asset management service module 202 for assets having a specified purchase order number. In a manner similar to that described above, the asset management service module 202 can identify assets having the specified purchase order number, can retrieve asset information identifying those assets, and can return the retrieved asset information to the requesting user, who can verify which assets are associated with the specified purchase order number.

In yet another example, leasing department personnel can track leased assets having a specified end-of-lease (EOL) date so that late fees and penalties can be minimized. In this embodiment, a user can invoke the asset manager component 220 and submit a request to the asset management service module 202 for assets having an EOL date within a specified time period, e.g., 30 days before the EOL date. In a manner similar to that described above, the asset management service module 202 can identify assets having an EOL date within the specified time period, can retrieve asset information identifying those assets, and can return the retrieved asset information to the requesting user, who can then locate and process the leased assets before the EOL date.

In another embodiment, the asset management service module 202 need not necessarily rely on a request from the user system 210. Rather, the asset management service module 202 can be accessible via an application programming interface (API). For example, in an embodiment, an API (not shown) can be used to detect automatically triggered requests which can be generated by an application based on any desired predetermined or user-configurable rule. The application, which might be included in the user system 210 or in the node 201, can receive the requested information, and can automatically process the information. For example, an application can automatically trigger a request for users assigned to assets having an EOL date within a specified time period, and the API can detect and submit that request to the asset management service module 202. When the information identifying the users is received via the API, the application can automatically send messages to the users notifying them of the EOL date and instructing them to contact specified personnel.

In other embodiments, the asset information can include information that links an asset to other assets. For example, a server can be one of several servers in a server farm or cluster. The server cluster can be associated with an identifier, such as a cluster name, and each of the servers can be associated with the cluster name and therefore to each other. Accordingly, when an event is detected with one of the servers in the cluster, the other servers associated with the cluster can be monitored.

### System Overview

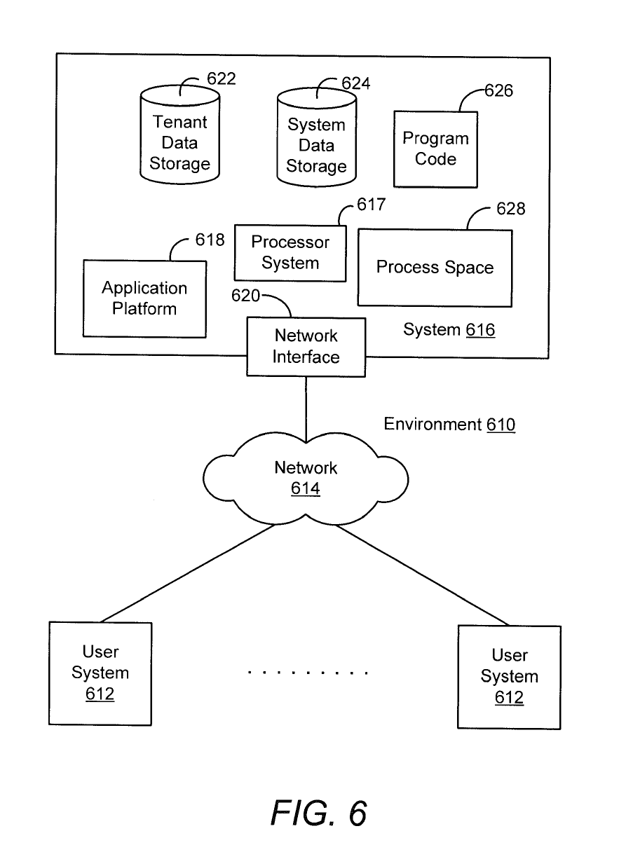

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

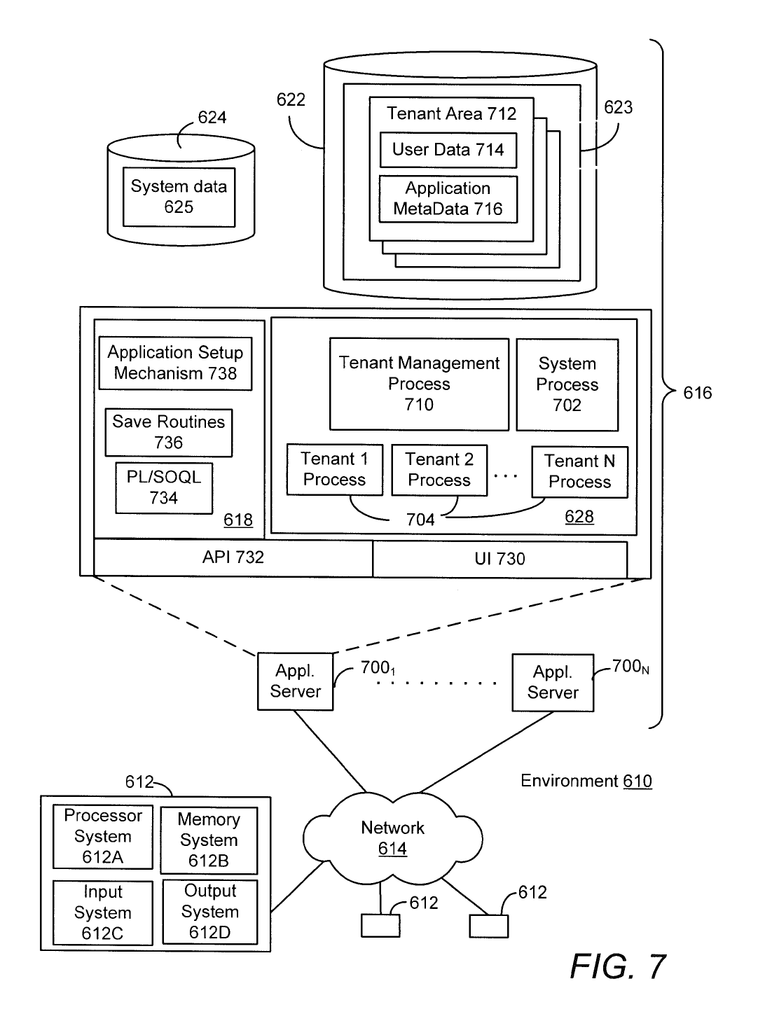

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user data storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700₁-700_{N}, an application platform 618, tenant data storage 622, and system data storage 624. Also shown is system process space 702, including individual tenant process spaces 704 and a tenant management process space 710. Each application server 700₁-700_{N} may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user data storage 714 and application metadata 716 might be similarly allocated for each user. For example, a copy of a user's most recently used (MRU) items might be stored to user data storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data 623 and the system data 625 may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 716 for the subscriber making the invocation and executing the metadata as an application in a virtual machine.

Each application server 700₁-700_{N} may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700₁-700_{N} and the database system. However, it will be apparent to one skilled in the art that other transport protocols may be used to optimize the system depending on the network interconnect used.

In certain embodiments, each application server 700₁-700_{N} is configured to handle requests for any user associated with any organization that is a tenant. Because it is desirable to be able to add and remove application servers from the server pool at any time for any reason, there is preferably no server affinity for a user and/or organization to a specific application server 700₁-700_{N}. In one embodiment, therefore, an interface system implementing a load balancing function (e.g., an F5 Big-IP load balancer) is communicably coupled between the application servers 700₁-700_{N} and the user systems 612 to distribute requests to the application servers 700₁-700_{N}. In one embodiment, the load balancer uses a least connections algorithm to route user requests to the application servers 700₁-700_{N}. Other examples of load balancing algorithms, such as round robin and observed response time, also can be used. For example, in certain embodiments, three consecutive requests from the same user could hit three different application servers 700₁-700_{N}, and three requests from different users could hit the same application server 700₁-700_{N}. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700₁-700_{N} to request and update system-level and tenant-level data from system 616 that may require sending one or more queries to tenant data storage 622 and/or system data storage 624. System 616 (e.g., an application server 700₁ in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method for managing an asset in a database system, the method comprising:
receiving by a node hosting an asset management service module asset information corresponding to an asset;
generating automatically by the asset management service an asset identifier based on the received asset information, wherein the asset identifier uniquely identifies the asset and includes a manufacturer's serial number of the asset and at least one of a make and a model of the asset;
associating the asset information with the asset identifier; and
storing the asset information and the asset identifier in a database system.

2. The method of claim 1 wherein receiving asset information comprises receiving the asset information over a network, wherein the network is at least one of a public and a private network, and wherein the database system is a multi-tenant on-demand database system.

3. The method of claim 1 wherein receiving asset information includes receiving asset information corresponding to a plurality of assets, wherein generating an asset identifier includes generating a plurality of asset identifiers for each of the plurality of assets; wherein associating the asset information includes associating the asset information of each of the plurality of assets with each of the plurality of asset identifiers, and wherein storing the asset information includes storing the asset information of each of the plurality of assets and each of the plurality of asset identifiers in the database system.

4. The method of claim 1 wherein the asset information includes at least one of a location of the asset, a status of the asset, technical specifications of the asset, and financial information.

5. The method of claim 1 further comprising:
receiving user data by the node hosting the asset management service module, wherein the user data comprises a user name, the asset identifier associated with the asset, and at least one of an asset transaction number, a use type, a status, an issue date, and a return date;
associating the user data with the asset identifier of the asset; and
storing the user data in the database system, wherein the user data identifies at least one user associated with the asset for tracking at least one user of the asset.

6. The method of claim 1 further comprising:
receiving support data by the node hosting the asset management service module, wherein the support data comprises a support case number, the asset identifier, and at least one of a problem description, a contact name, a priority, a status, and an open date and time;
associating the support data with the asset identifier of the asset; and
storing the support data in the database system, wherein the support data identifies at least one support case associated with the asset for tracking technical problems of the asset.

7. The method of claim 6 further comprising:
receiving by the node hosting the asset management service module a request for at least one asset having a specified problem description;
identifying by the asset management service module the at least one asset having the specified problem description; and
retrieving asset information identifying the at least one asset, such that the at least one asset having the specified problem description is tracked.

8. The method of claim 1 wherein the asset is a leased asset and the corresponding asset information includes an end-of-lease date for the asset, the method further comprising:
receiving by the node hosting the asset management service module a request for an asset having an end-of-lease date within a specified time period;
identifying by the asset management service the asset having an end-of-lease date within the specified time period, and
retrieving asset information identifying the leased asset, such that the leased asset can be located and processed before the end-of-lease date.

9. The method of claim 1 wherein the asset information includes a purchase order number associated with the asset, the method further comprising:
receiving by the node hosting the asset management service module a request for at least one asset having a specified purchase order number;
identifying by the asset management service module the at least one asset having the specified purchase order number; and
retrieving asset information identifying the at least one asset, such that the at least one asset having the specified purchase order number is verified.

10. A machine-readable medium carrying one or more sequences of instructions for managing an asset in a database system, which instructions, when executed by one or more processors, cause the one or more processors to carry out the steps of:
receiving by an asset management service asset information corresponding to an asset;
generating automatically by the asset management service an asset identifier based on the received asset information, wherein the asset identifier uniquely identifies the asset and includes a manufacturer's serial number of the asset and at least one of a make and a model of the asset;
associating the asset information with the asset identifier; and
storing the asset information and the asset identifier in a database system.

11. An apparatus for managing an asset in a database system, the apparatus comprising:
a processor; and
one or more stored sequences of instructions which, when executed by the processor, cause the processor to carry out the steps of:
receiving by an asset management service asset information corresponding to an asset;
generating automatically by the asset management service an asset identifier based on the received asset information, wherein the asset identifier uniquely identifies the asset and includes a manufacturer's serial number of the asset and at least one of a make and a model of the asset;
associating the asset information with the asset identifier; and
storing the asset information and the asset identifier in a database system.

12. A method for transmitting code for managing an asset in a database system on a transmission medium, the method comprising:
transmitting code to receive by an asset management service asset information corresponding to an asset;
transmitting code to generate automatically by the asset management service an asset identifier based on the received asset information, wherein the asset identifier uniquely identifies the asset and includes a manufacturer's serial number of the asset and at least one of a make and a model of the asset;
transmitting code to associate the asset information with the asset identifier; and
transmitting code to store the asset information and the asset identifier in a database system.

13. A method for managing assets, the method comprising:
receiving asset information corresponding to an asset by an asset manager component; and
sending the asset information to a node hosting an asset management service module configured for storing the asset information in a database system.

14. The method of claim 13 further comprising generating automatically an asset identifier associated with the asset based on an asset serial number, wherein the asset identifier uniquely identifies the asset and includes a manufacturer's serial number of the asset and at least one of a make and a model of the asset, and wherein sending the asset information includes sending the asset identifier to the node hosting the asset management service module.

15. The method of claim 13 wherein sending the asset information comprises sending over a network, wherein the network is at least one of a public and a private network, and wherein the database system is a multi-tenant on-demand database system.

16. The method of claim 13 wherein the asset information is received via at least one of manual input by a user, audio input by a user, a scanning device, and an imaging device.

17. The method of claim 13 wherein prior to sending the asset information, the method further comprises receiving asset information corresponding to a plurality of assets and generating a plurality of asset identifiers associated with each of the plurality of assets.

18. The method of claim 17 wherein sending the asset information comprises sending asset information corresponding to the plurality of assets, wherein the asset information includes the plurality of asset identifiers associated with each of the plurality of assets.

19. The method of claim 13 further comprising:
receiving user data by the asset manager component, wherein the user data comprises a user name, an asset identifier associated with the asset, and at least one of an asset transaction number, a use type, a status, an issue date, and a return date; and
sending the user data to the node hosting the asset management service module configured for associating the user data with the asset identifier, and for storing the user data in the database system.

20. The method of claim 13 further comprising:
receiving support data by the asset manager component, wherein the support data comprises a support case number, an asset identifier associated with the asset, and at least one of a problem description, a contact name, a priority, a status, and an open date and time; and
sending the support data to the node hosting the asset management service module configured for associating the support data with the asset identifier, and for storing the support data in the database system.

21. The method of claim 20 further comprising:
receiving by the asset manager component a request for at least one asset having a specified problem description;
sending the request to the node hosting the asset management service module configured for identifying and retrieving at least one asset having the specified problem description;
receiving, in response to the request, asset information identifying at least one asset having the specified problem description; and
tracking automatically the at least one asset.

22. The method of claim 13 wherein the asset is a leased asset and the corresponding asset information includes an end-of-lease date for the asset, the method further comprising:
receiving by the asset manager component a request for at least one asset having an end-of-lease date within a specified time period;
sending the request to the node hosting the asset management service module configured for identifying and retrieving the at least one asset having the end-of-lease date within the specified time period;
receiving, in response to the request, asset information identifying the at least one asset having the end-of-lease date within the specified time period; and
locating and processing the at least one asset before the end-of-lease date.

23. The method of claim 13 wherein the asset information includes a purchase order number associated with the asset, the method further comprising:
receiving by the asset manager component a request for at least one asset having a specified purchase order number;
sending the request to the node hosting the asset management service module configured for identifying and retrieving the at least one asset having the specified purchase order number;
receiving, in response to the request, asset information identifying the at least one asset having the specified purchase order number; and
verifying that the at least one asset is associated with the specified purchase order number.

24. A machine-readable medium carrying one or more sequences of instructions for managing an asset, which instructions, when executed by one or more processors, cause the one or more processors to carry out the steps of:
receiving asset information corresponding to an asset by an asset manager component; and
sending the asset information to a node hosting an asset management service module configured for storing the asset information in a database system.

25. An apparatus for managing an asset, the apparatus comprising:
a processor; and
one or more stored sequences of instructions which, when executed by the processor, cause the processor to carry out the steps of:
receiving asset information corresponding to an asset by an asset manager component; and
sending the asset information to a node hosting an asset management service module configured for storing the asset information in a database system.

26. A method for transmitting code for managing an asset on a transmission medium, the method comprising:
transmitting code to receive asset information corresponding to an asset by an asset manager component; and
transmitting code to send the asset information to a node hosting an asset management service module configured for storing the asset information in a database system.
